(19) United States
(12) Patent Application Publication
(10) Pub. No.: US 2012/0218208 A1
(43) Pub. Date: Aug. 30, 2012

(54) ELECTRONIC DEVICE, OPERATION CONTROL METHOD, AND STORAGE MEDIUM STORING OPERATION CONTROL PROGRAM

(75) Inventors: Takayuki SATO, Yokohama-shi (JP); Makiko HOSHIKAWA, Daito-shi (JP); Tomohiro SHIMAZU, Daito-shi (JP)

(73) Assignee: KYOCERA CORPORATION, Kyoto (JP)

(21) Appl. No.: 13/404,142

(22) Filed: Feb. 24, 2012

(30) Foreign Application Priority Data
Feb. 24, 2011 (JP) 2011-039092

(51) Int. Cl. G06F 3/041

(52) U.S. Cl. 345/173

(57) ABSTRACT

According to an aspect, an electronic device includes a display unit, a contact detecting unit, a control unit. The display unit displays a first image. The contact detecting unit detects a contact. when the contact detecting unit detects an operation in which a plurality of contacts including at least a first contact and a second contact are made and thereafter the first contact is moved in a direction approaching to the second contact, the control unit causes the first image displayed on the display unit to be distorted.

### CROSS-REFERENCE TO RELATED APPLICATIONS

This application claims priority from Japanese Application No. 2011-039092, filed on Feb. 24, 2011, the content of which is incorporated by reference herein in its entirety.

### BACKGROUND

1. Technical Field

The present invention relates to an electronic device, an operation control method, and a storage medium storing therein an operation control program.

2. Description of the Related Art

Recently, in order to allow an intuitive operation and realize a small-size electronic device that does not include a device requiring a physically large area such as a keyboard, touch panels are widely used. As an electronic device that includes a touch panel, there is an electronic device that zooms in or out an image to be displayed based on an operation input to the touch panel (see Japanese Patent Application Laid-Open No. 2003-8886).

However, in the above-discussed method of zooming in or out an image, since the size of an image changes, it may be difficult to detect the size used as a reference. Further, while a screen is being switched by various operations, it may be difficult to intuitively recognize whether or not an image has been zoomed in or out by a user's operation.

For the foregoing reasons, there is a need for an electronic device, an operation control method, and an operation control program that allow a user to recognize an input operation intuitively.

### SUMMARY

According to an aspect, an electronic device includes a display unit, a contact detecting unit, a control unit. The display unit displays a first image. The contact detecting unit detects a contact. when the contact detecting unit detects an operation in which a plurality of contacts including at least a first contact and a second contact are made and thereafter the first contact is moved in a direction approaching to the second contact, the control unit causes the first image displayed on the display unit to be distorted.

According to another aspect, an operation control method is executed by an electronic device including a display unit and a contact detecting unit. The operation control method includes: displaying an image on the display unit; detecting, by the contact detecting unit, an operation in which a plurality of contacts including at least a first contact and a second contact are made and thereafter the first contact is moved in a direction approaching to the second contact; and distorting the image displayed on the display unit when the operation is detected.

According to another aspect, a non-transitory storage medium stores therein an operation control program. When executed by an electronic device which includes a display unit and a contact detecting unit, the operation control program causes the electronic device to execute: displaying an image on the display unit; detecting, by the contact detecting unit, an operation in which a plurality of contacts including at least a first contact and a second contact are made and thereafter the first contact is moved in a direction approaching to the second contact; and distorting the image displayed on the display unit when the operation is detected.

### BRIEF DESCRIPTION OF THE DRAWINGS

FIG. 1 is a perspective view of a mobile phone;

FIG. 2 is a front view of the mobile phone;

FIG. 3 is a block diagram of the mobile phone;

FIG. 4 is a diagram illustrating an example of control executed by a control unit according to an operation detected by a contact sensor;

FIG. 5 is a diagram illustrating an example of control executed by the control unit according to an operation detected by the contact sensor;

FIG. 6 is a diagram illustrating an example of control executed by the control unit according to an operation detected by the contact sensor;

FIG. 7 is a diagram illustrating an example of control executed by the control unit according to an operation detected by the contact sensor;

FIG. 8 is a flowchart illustrating an operation of the mobile phone; and

FIG. 9 is a flowchart illustrating an operation of the mobile phone.

### DETAILED DESCRIPTION

The present invention will be described in detail with reference to the drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the electronic device, however, the present invention is not limited to mobile phones. Therefore, the present invention can be applied to various types of devices, including but not limited to personal handyphone systems (PHS), personal digital assistants (PDA), portable navigation units, personal computers (including but not limited to tablet computers, netbooks etc.), media players, portable electronic reading devices, and gaming devices.

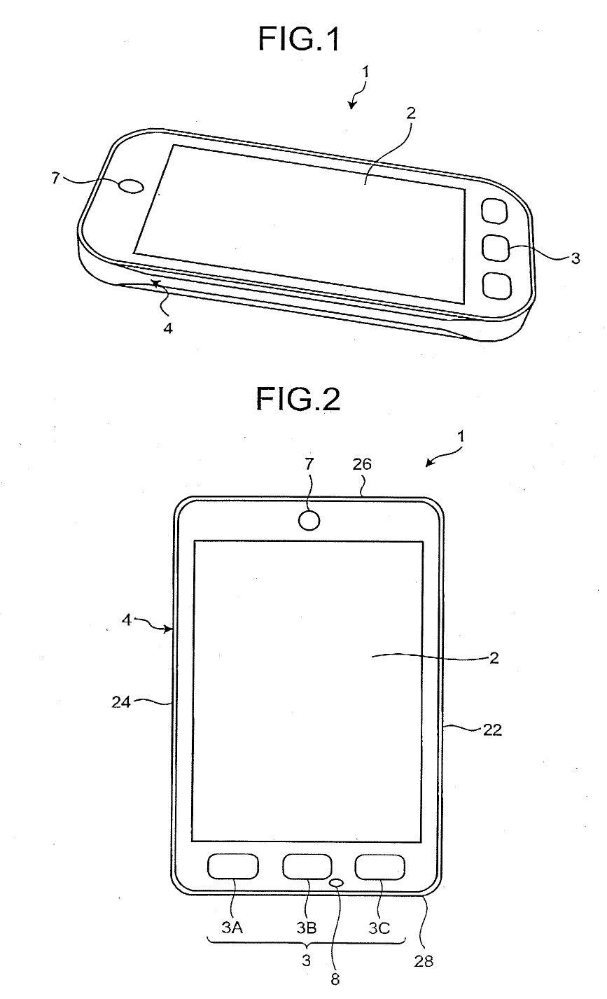

First, an overall configuration of a mobile phone 1 as an electronic device according to an embodiment will be described with reference to FIGS. 1 and 2. FIG. 1 is a perspective view of the mobile phone 1. FIG. 2 is a front view of the mobile phone 1. As illustrated in FIGS. 1 and 2, the mobile phone 1 includes a housing that has an approximately hexahedral shape having two faces the area of which is larger than the other faces, and a touch panel 2, an input unit 3, a contact sensor 4, a speaker 7, and a microphone 8, which are arranged on the surface of the housing.

The touch panel 2 is disposed on one of faces (a front face) having the largest area. The touch panel 2 displays a text, a graphic, an image, or the like, and, detects various operations (gestures) performed by a user on the touch panel 2 by using his/her finger, a stylus, a pen, or the like (in the description herein below, for the sake of simplicity, it is assumed that the user touches the touch panel 2 with his/her fingers). The detection method of the touch panel 2 may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. The input unit 3 includes a plurality of buttons such as a button 3A, a button 3B, and a button 3C to which predetermined functions are assigned. The speaker 7 outputs a voice of a call opponent, music or an effect sound reproduced by various programs, and the like. The microphone 8 acquires a voice during a phone call or upon receiving an operation by a voice.

The contact sensor 4 is disposed on a face (a side face) that comes into contact with the face on which the touch panel 2 is disposed. The contact sensor 4 detects various operations that the user performs for the contact sensor 4 by using his/her finger. Under the assumption that the face on which the touch panel 2 is disposed is the front face, the contact sensor 4 includes the right contact sensor 22 disposed on the right side face, the left contact sensor 24 disposed on the left side face, the upper contact sensor 26 disposed on the upper side face, and the lower contact sensor 28 disposed on the lower side face. The detection method of the right contact sensor 22 and the like may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. Each of the right contact sensor 22, the left contact sensor 24, the upper contact sensor 26, and the lower contact sensor 28 can detect a multi-point contact. For example, when two fingers are brought into contact with the right contact sensor 22, the right contact sensor 22 can detect respective contacts of the two fingers at the positions with which the two fingers are brought into contact.

The mobile phone 1 includes the contact sensor 4 in addition to the touch panel 2 and thus can provide the user with various operation methods that are intuitive and superior in operability as will be described below.

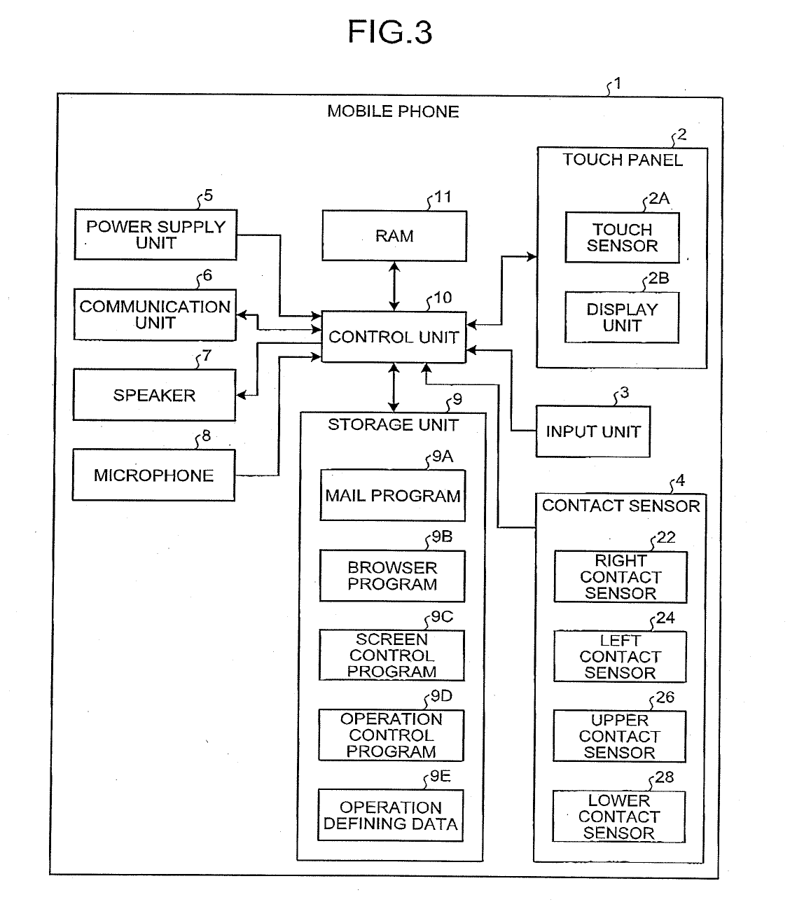

Next, a functional configuration of the mobile phone 1 will be described with reference to FIG. 3. FIG. 3 is a block diagram of the mobile phone 1. As illustrated in FIG. 3, the mobile phone 1 includes the touch panel 2, the input unit 3, the contact sensor 4, a power supply unit 5, a communication unit 6, the speaker 7, the microphone 8, a storage unit 9, a control unit 10, and a random access memory (RAM) 11.

The touch panel 2 includes a display unit 2B and a touch sensor 2A that is arranged on the display unit 2B in a superimposed manner. The touch sensor 2A detects various operations performed on the touch panel 2 using the finger as well as the position on the touch panel 2 at which the operation is made and notifies the control unit 10 of the detected operation and the detected position. Examples of the operations detected by the touch sensor 2A include a tap operation and a sweep operation. The display unit 2B is configured with, for example, a liquid crystal display (LCD), an organic electro-luminescence display (GELD), or the like and displays a text, a graphic, and so on.

The input unit 3 receives the user's operation through a physical button or the like and transmits a signal corresponding to the received operation to the control unit 10. The contact sensor 4 includes the right contact sensor 22, the left contact sensor 24, the upper contact sensor 26, and the lower contact sensor 28. The contact sensor 4 detects various operations performed on these sensors as well as the positions at which the operations are made, and notifies the control unit 10 of the detected operation and the detected position. The power supply unit 5 supplies electric power acquired from a battery or an external power supply to the respective functional units of the mobile phone 1 including the control unit 10.

The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs a sound signal transmitted from the control unit 10 as a sound. The microphone 8 converts, for example, the user's voice into a sound signal and transmits the converted sound signal to the control unit 10.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. The programs stored in the storage unit 9 include a mail program 9A, a browser program 9B, a screen control program 9C, and an operation control program 9D. The data stored in the storage unit 9 includes operation defining data 9E. In addition, the storage unit 9 stores programs and data such as an operating system (OS) program for implementing basic functions of the mobile phone 1, address book data, and the like. The storage unit 9 may be configured with a combination of a portable storage medium such as a memory card and a storage medium reading device.

The mail program 9A provides a function for implementing an e-mail function. The browser program 9B provides a function for implementing a web browsing function. The screen control program 9C displays a text, a graphic, or the like on the touch panel 2 in cooperation with functions provided by the other programs. The operation control program 9D provides a function for executing processing according to various contact operations detected by the touch sensor 2A and the contact sensor 4. The operation defining data 9E maintains a definition on a function that is activated according to a detection result of the contact sensor 4.

The control unit 10 is, for example, a central processing unit (CPU) and integrally controls the operations of the mobile phone 1 to realize various functions. Specifically, the control unit 10 implements various functions by executing a command included in a program stored in the storage unit 9 while referring to data stored in the storage unit 9 or data loaded to the RAM 11 as necessary and controlling the display unit 2B, the communication unit 6, or the like. The program executed or the data referred to by the control unit 10 may be downloaded from a server apparatus through wireless communication through the communication unit 6.

For example, the control, unit 10 executes the mail program 9A to implement an electronic mail function. The control unit 10 executes the operation control program 9D to implement a function for performing corresponding processing according to various contact operations detected by the touch sensor 2A and the contact sensor 4. The control unit 10 executes the screen control program 9C to implement a function for displaying a screen and the like used for various functions on the touch panel 2. In addition, it is assumed that the control unit 10 can execute a plurality of programs in a parallel manner through a multitasking function provided by the OS program.

The RAM 11 is used as a storage area in which a command of a program executed by the control unit 10, data referred to by the control unit 10, a calculation result of the control unit 10, and the like are temporarily stored.

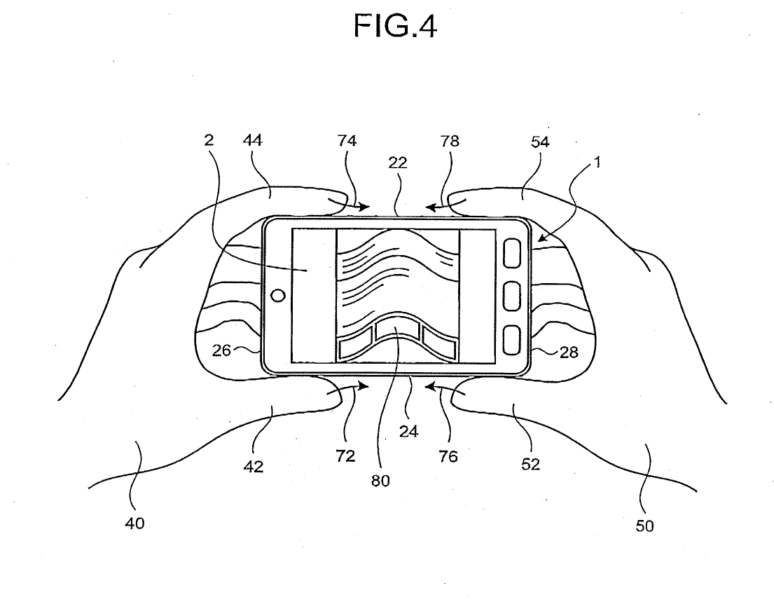

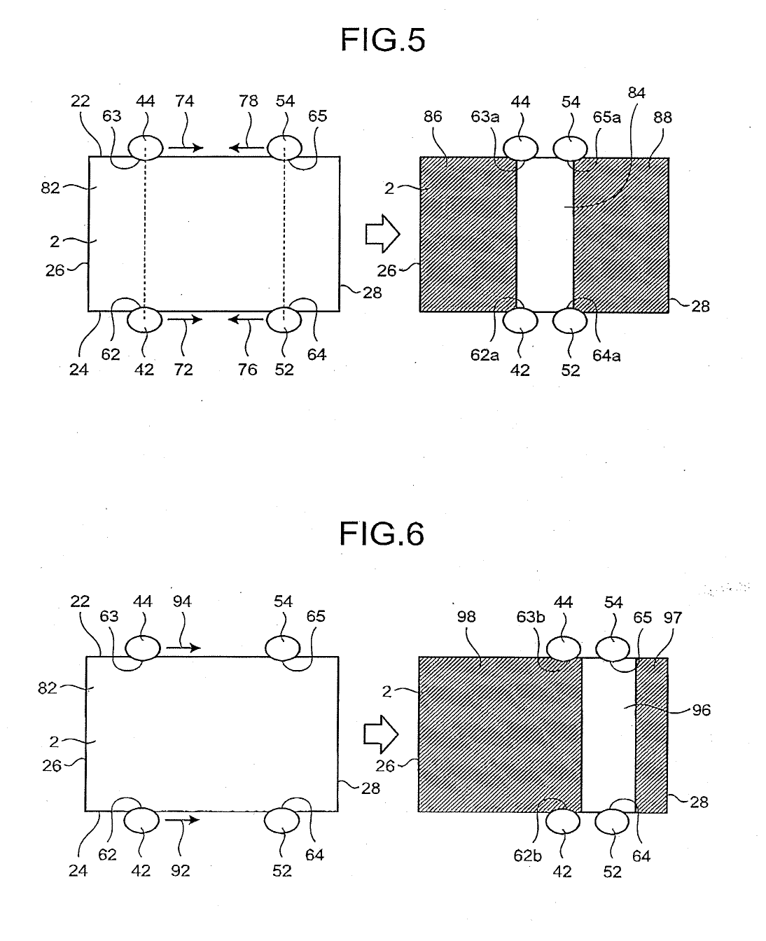

Next, an example of control executed by the control unit 10 according to an operation detected by the contact sensor 4 will be described with reference to FIGS. 4 and 5. FIGS. 4 and 5 are diagrams illustrating examples of control executed by the control unit according to an operation detected by the contact sensor 4, respectively. FIG. 4 is a diagram concretely illustrating a relation between the mobile phone 1 and hands (a left hand 40 and a right hand 50) operating the mobile phone 1. FIG. 5 is a diagram schematically illustrating a relation among the contact sensor 4, a screen of an operation target, and the finger. In FIG. 5, a housing portion of the outer circumference of the touch panel 2 is not illustrated.

The mobile phone 1 illustrated in FIG. 4 is supported by the user's left hand 40 and right hand 50 in a direction in which a longitudinal direction of the touch panel 2 is a horizontal direction. Specifically, the left hand 40 supports a portion of the left contact sensor 24 at the upper contact sensor 26 side with a thumb 42 and supports a portion of the right contact sensor 22 at the upper contact sensor 26 side with an index finger 44. The right hand 50 supports a portion of the left contact sensor 24 at the lower contact sensor 28 side with a thumb 52 and supports a portion of the right contact sensor 22 at the lower contact sensor 28 side with an index finger 54. In a state in which support is made with the four fingers as described above, in the mobile phone 1, a contact at a contact point 62 of the thumb 42 is detected by the left contact sensor 24, a contact at a contact point 63 of the index finger 44 is detected by the right contact sensor 22, a contact at a contact point 64 of the thumb 52 is detected by the left contact sensor 24, and a contact at a contact point 65 of the index finger 54 is detected by the right contact sensor 22 as illustrated in the left drawing of FIG. 5. That is, the right contact sensor 22 detects the contacts at the two points, that is, the contact point 63 and the contact point 65. The left contact sensor 24 detects the contacts at the two points, that is, the contact point 62 and the contact point 64. The contact point 62 and the contact point 63 are substantially the same in the position in the longitudinal direction (a direction in which the right contact sensor 22 and the left contact sensor 24 extend). The contact point 64 and the contact point 65 are substantially the same in the position in the longitudinal direction. Thus, the contact point 62 and the contact point 63 can be connected to each other by a straight line parallel to a transverse direction, and the contact point 64 and the contact point 65 can be connected to each other by a straight line parallel to the transverse direction. The straight lines parallel to a transverse direction do not have to passes through the corresponding contact points exactly, but the straight lines preferably pass through near the corresponding contact points, respectively. In other words, preferably, the positions of the contact points can be approximated to connect to each other by a straight line parallel to the transverse direction. In the present embodiment, the straight line connecting the two contact points is referred to as a contact position.

In the state illustrated in a left drawing of FIG. 5, an image is displayed on a display area 82 of the whole screen of the touch panel 2. An image (object) displayed on the display area 82 is an operation target image (object), and various images can be used as the operation target image. For example, a window image representing an execution screen of an arbitrary application may be used as the image (object) displayed on the display area 82.

In the state illustrated in the left drawing of FIG. 5, the user moves the thumb 42 in a direction of an arrow 72, moves the index finger 44 in a direction of an arrow 74, moves the thumb 52 in a direction of an arrow 76, and moves the index finger 54 in a direction of an arrow 78. In other words, the user moves the index finger 44 and the index finger 54 that are brought into contact with the left contact sensor 24 in a direction closer to each other. Further, the user moves the thumb 42 and the thumb 52 that are brought into contact with the right contact sensor 22 in a direction closer to each other. By moving the fingers as described above, the user moves the thumb 42 to a contact point 62a, moves the index finger 44 to a contact point 63a, moves the thumb 52 to a contact point 64a, and moves the index finger 54 to a contact point 65a as illustrated in a right drawing of FIG. 5. In the present embodiment, an operation of reducing a distance between fingers (an operation of putting contact positions closer to each other) coming into contact with the contact sensor 4 as illustrated from the left drawing to the right drawing of FIG. 5 is referred to as a “crumpling operation”. The operation of moving a contact point is a sweep operation (slide operation) of moving a contact point while maintaining a contact with the contact sensor.

When the crumpling operation is input, the left contact sensor 24 detects an operation of moving the contact point 62 to the contact point 62a and moving the contact point 64 to the contact point 64a, and the right contact sensor 22 detects an operation of moving the contact point 63 to the contact point 63a and moving the contact point 65 to the contact point 65a. The contact sensor 4 notifies the control unit 10 of the detection result.

The control unit 10 changes an image displayed on the touch panel 2 based on a function provided by the operation control program 9D when the operation for decreasing the distance between the contacting fingers is detected by the contact sensor 4, that is, in the present embodiment, when an operation of putting a straight line (contact position), parallel to the transverse direction, approximated by a pair of contact points (contact points 62 and 63) among a plurality of contact points detected by the right contact sensor 22 and a plurality of contact points detected by the left contact sensor 24, which are opposite to each other, and a straight line (contact position), parallel to the transverse direction, approximated by another pair of the contact points (contact points 64 and 65), closer to each other is detected by the contact sensor 4. Specifically, the control unit 10 reduces the image such that the display area 82 where the image is displayed on the touch panel 2 is reduced, for example, to a display area 84, and causes the image to be displayed on the center of the touch panel 2 as illustrated in FIG. 5. The display area 84 is an area having the size reduced based on a distance by which the two contact positions are closer to each other. Thus, the image displayed on the display area 82 is not displayed on a display area 86 and a display area 88 excluding the display area 84 from the display area 82 on which the image has been displayed. Further, the control unit 10 crumples and distorts the image displayed on the display area 84 according to a shrinkage amount of the display area, and causes the resultant image (wrinkles) to be displayed. As the image is crumpled, a behavior of crumpling a paper with hands is reproduced through an image. In other words, like an image 80 illustrated in FIG. 4, the outer circumference (the outer edge) of the image is bent, and an internal image is also bent according to the curvature of the outer circumference. Preferably, the bending position or the bending shape is randomly decided. In the process illustrated in FIG. 4, an image is crumpled in one direction (the longitudinal direction). However, an image may be crumpled in two directions (the longitudinal direction and the transverse direction). Further, when an image is crumpled, the control unit 10 preferably bends the outer circumference while maintaining a total length of the outer circumference of an image. Thus, an image similar to when a paper is actually crumpled can be reproduced.

As described above, when the contact sensor 4 detects the crumpling operation, the mobile phone 1 changes a display area of an image displayed on the touch panel 2, crumples the displayed image, and displays the crumpled image. Thus, in the mobile phone 1, it can be intuitively understood whether or not an image displayed on the touch panel 2 is an image whose display area is reduced.

When the display area is reduced by a predetermined area or more through the crumpling operation, that is, when a distance between contact positions is a threshold distance or less, the mobile phone 1 may execute an image deletion process. As a function of deleting information is allocated to the crumpling operation, a displayed image is crumpled according to the crumpling operation, a crumpled image is then displayed on the touch panel 2, and thereafter corresponding data is deleted. An operation of crumpling an image and then throwing the crumpled image into a trash can be implemented as an image, and thus an intuitive operation can be implemented.

An operation detected as the crumpling operation is not limited to the inputs illustrated in FIG. 5. The control unit 10 may detect various operations for putting contact positions, at which the fingers are brought into contact with the contact sensor 4, closer to each other as the crumpling operation. Specifically, an operation in which a sweep operation of putting a plurality of contact points closer is performed by moving at least one contact position (a sweep operation of moving at least one contact position in a direction of reducing a distance between contact positions in a state in which contacts are made at a plurality of contact positions) may be detected as the crumpling operation. An operation defined as the crumpling operation is preferably defined in the operation defining data 9E in advance. That is, an operation for putting contact positions, at which the fingers are brought into contact with the contact sensor 4, closer to each other may be defined as an operation other than the crumpling operation.

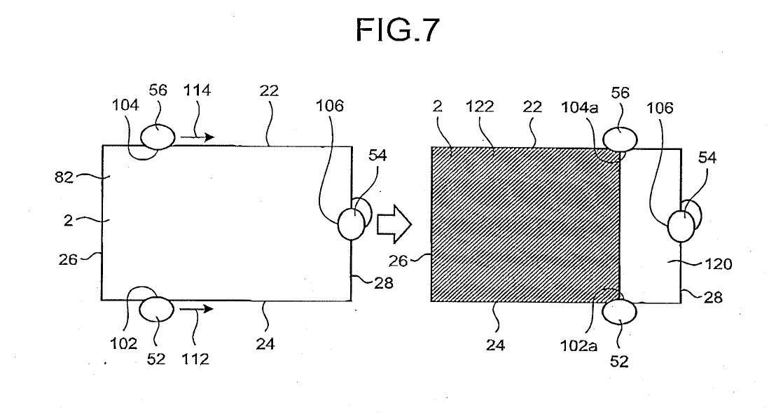

Next, another example of the crumpling operation will be described with reference to FIGS. 6 and 7. FIGS. 6 and 7 are diagrams illustrating examples of control executed by the control unit 10 according to an operation detected by the contact sensor 4, respectively. FIGS. 6 and 7 schematically illustrate examples of an operation which can be defined as the crumpling operation, respectively.

First, an operation illustrated in FIG. 6 will be described. A mobile phone 1 illustrated in FIG. 6 is supported by four fingers similarly to the example illustrated in FIG. 5. Specifically, a portion of the left contact sensor 24 at the upper contact sensor 26 side is supported by the left thumb 42, and a portion of the right contact sensor 22 at the upper contact sensor 26 side is supported by the index finger 44. Further, a portion of the left contact sensor 24 at the lower contact sensor 28 side is supported by the right thumb 52, and a portion of the right contact sensor 22 at the lower contact sensor 28 side is supported by the index finger 54. Thus, in the mobile phone 1, similarly to the left drawing of FIG. 5, a contact at a contact point 62 of the thumb 42 is detected by the left contact sensor 24, a contact at a contact point 63 of the index finger 44 is detected by the right contact sensor 22, a contact at a contact point 64 of the thumb 52 is detected by the left contact sensor 24, and a contact at a contact point 65 of the index finger 54 is detected by the right contact sensor 22 as illustrated in the left drawing of FIG. 6. In the state illustrated in the left drawing of FIG. 6, an image is displayed on the display area 82 of the whole screen of the touch panel 2.

In the state illustrated in the left drawing of FIG. 6, the user moves the thumb 42 in a direction of an arrow 92, moves the index finger 44 in a direction of an arrow 94, but maintains (does not move) the thumb 52 and the index finger 54 at the same position. In other words, the index finger 44 that is brought into contact with the right contact sensor 22 is moved in a direction closer to the index finger 54. Further, the thumb 42 that is brought into contact with the left contact sensor 24 is moved in a direction closer to the thumb 52. By moving the fingers as described above, the user moves the thumb 42 to a contact point 62b, and moves the index finger 44 to a contact point 63b as illustrated in a right drawing of FIG. 6. Further, the thumb 52 remains brought into contact with the contact point 64, and the index finger 54 remains brought into contact with the contact point 65. As illustrated from the left drawing to the right drawing of FIG. 6, an operation of putting one contact position closer to the other contact position without moving the other contact position at which the finger comes into contact with the contact sensor 4 can be also defined as the “crumpling operation.” In the example illustrated in FIG. 6, a straight line obtained by connecting two contact points arranged at corresponding positions is used as a contact position.

When the crumpling operation illustrated in FIG. 6 is input, the left contact sensor 24 detects an operation of moving the contact point 62 to the contact point 62b, and the right contact sensor 22 detects an operation of moving the contact point 63 to the contact point 63b. The contact sensor 4 notifies the control unit 10 of the detection result. The control unit 10 changes the image displayed on the touch panel 2 based on a function provided by the operation control program 9D when an operation for putting contact positions closer to each other is detected by the contact sensor 4 as described above. For example, the control unit 10 reduces the image such that the display area 82 where the image is displayed on the touch panel 2 is reduced, for example, to a display area 96, and causes the image to be displayed on the center of the touch panel 2 as illustrated in FIG. 6. The display area 96 is an area having the size reduced based on a distance by which contact positions are closer to each other. The contact points 64 and 65 are not moved, but as the contact points 62 and 63 are moved to the contact points 62b and 63b, the display area at the non-moved contact position side may be also reduced. Thus, the image displayed on the display area 82 is not displayed on a display area 97 and a display area 98 excluding the display area 96 from the display area 82 on which the image has been displayed. Further, the control unit 10 crumples the image displayed on the display area 96 according to a shrinkage amount of the display area.

Next, an operation illustrated in FIG. 7 will be described. A mobile phone illustrated in FIG. 7 is supported by three fingers of the right hand. Specifically, a face on which the left contact sensor 24 is arranged is supported by the right thumb 52, a face on which the lower contact sensor 28 is arranged is supported by the index finger 54, and a face on which the right contact sensor 22 is arranged is supported by a middle finger 56. Thus, in the mobile phone 1, a contact at a contact point 102 of the thumb 52 is detected by the left contact sensor 24, a contact at a contact point 106 of the index finger 54 is detected by the lower contact sensor 28, and a contact at a contact point 104 of the middle finger 56 is detected by the right contact sensor 22 as illustrated in the left drawing of FIG. 7. In the state illustrated in the left drawing of FIG. 7, an image is displayed on the display area 82 of the whole screen of the touch panel 2.

In the state illustrated in the left drawing of FIG. 7, the user moves the thumb 52 in a direction of an arrow 112, moves the middle finger 56 in a direction of an arrow 114, but maintains (does not move) the index finger 54 at the same position. In other words, the middle finger 56 that is brought into contact with the right contact sensor 22 is moved in a direction closer to the lower contact sensor 28 (the index finger 54). Further, the thumb 52 that is brought into contact with the left contact sensor 24 is moved in a direction closer to the lower contact sensor 28. By moving the fingers as described above, the user moves the thumb 52 to a contact point 102a, and moves the middle finger 56 to a contact point 104a as illustrated in a right drawing of FIG. 7. Further, the index finger 54 remains brought into contact with the contact point 106. As illustrated from the left drawing to the right drawing of FIG. 7, an operation of putting one contact position closer to the other contact position by using a contact point on the lower contact sensor 28 as the other contact position at which the finger comes into contact with the contact sensor 4 can be also defined as the “crumpling operation.” That is, in addition to opposite two contact sensors of the contact sensor 4, a contact sensor perpendicular to the contact sensors can be used. In the example illustrated in FIG. 7, a straight line obtained by connecting two contact points arranged at corresponding positions is used as one of contact positions (a contact position of a moving side).

When the crumpling operation illustrated in FIG. 7 is input, the left contact sensor 24 detects an operation of moving the contact point 102 to the contact point 102a, and the right contact sensor 22 detects an operation of moving the contact point 104 to the contact point 104a. The contact sensor 4 notifies the control unit 10 of the detection result. The control unit 10 changes the image displayed on the touch panel 2 based on a function provided by the operation control program 9D when an operation for putting contact positions closer to each other is detected by the contact sensor 4 as described above. Specifically, the control unit 10 reduces the display area 82 where the image is displayed on the touch panel 2 to a display area 120 as illustrated in FIG. 7. The display area 120 is an area having the size reduced based on a distance by which contact positions are closer to each other. In the present embodiment, a display area at the contact point 106 (the contact position of the lower contact sensor 28) side is not reduced. Thus, the image displayed on the display area 82 is not displayed on a display area 122 excluding the display area 120 from the display area 82 on which the image has been displayed. Further, the control unit 10 crumples the image displayed on the display area 120 according to a shrinkage amount of the display area.

As illustrated in FIGS. 5 to 7, the mobile phone 1 preferably uses a straight line, which is obtained by approximating and connecting contact points detected by two opposite contact sensors of the contact sensor 4 and which is perpendicular to the side-face sensors, as at least one of contact positions of a crumpling operation. Thus, various processes can be allocated to other operations that can be detected by the contact sensor 4. Further, since an operation of reducing an area surrounded by a plurality of fingers can be defined as the crumpling operation, processing to be executed in response to an input operation can be intuitively easily understood.

An operation allocated to the crumpling operation is not limited thereto. For example, any one sensor of the contact sensor 4 may detect each of contacts of two points as a contact position. In this case, the mobile phone 1 detects an operation of reducing a distance between contacts of two points detected by one contact sensor as the crumpling operation.

The control unit 10 may detect a hand holding the housing based on information of a contact detected by the contact sensor 4, extract only a contact of a hand not holding the housing, and determine whether or not an operation input from the extracted contact is the crumpling operation. In this case, when an operation of reducing a distance between contact positions is detected from the contact of the hand not holding the housing, it is determined that the crumpling operation has been input. Thus, the display area of at least a part of an image displayed on the touch panel is reduced in a direction in which the distance of the corresponding operation is reduced, and the image is crumpled in a direction in which the distance of the corresponding operation is reduced. As described above, an operation is determined in view of a hand that has input an operation, and thus more operations can be input.

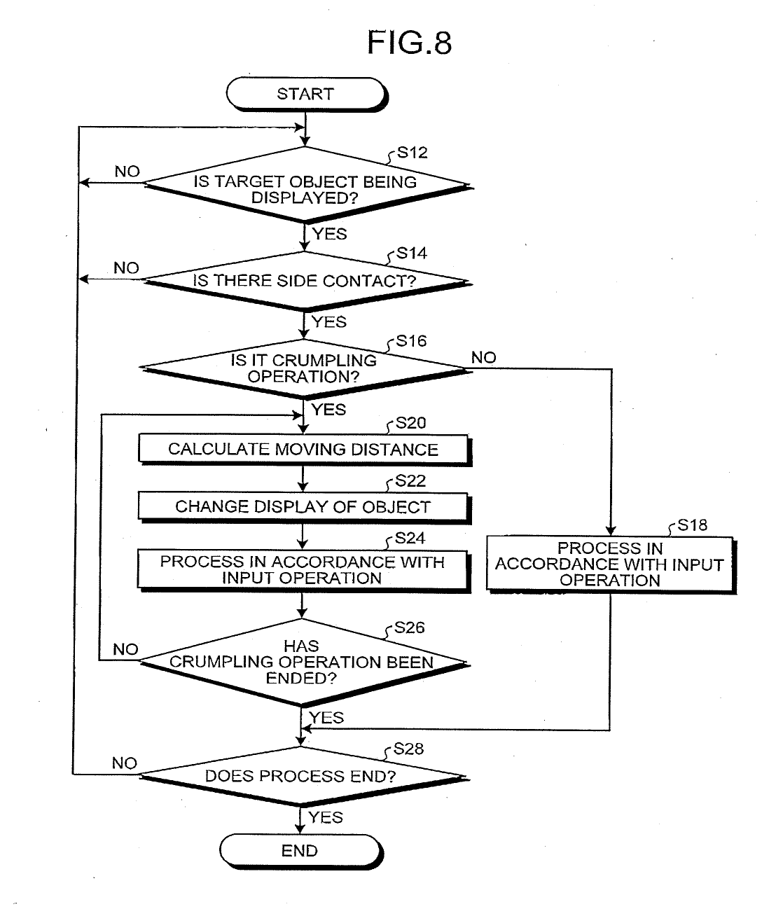

Next, an operation of the mobile phone 1 when a contact operation is detected will be described with reference to FIG. 8. FIG. 8 is a flowchart illustrating an operation of the mobile phone. A processing procedure illustrated in FIG. 8 is repetitively executed based on a function provided by the operation control program 9D.

At Step S12, the control unit 10 of the mobile phone 1 determines whether a target object is being displayed. The target object refers to an object (image) whose display area or display can be changed by the crumpling operation. When it is determined that the target object is not being displayed (No at Step S12), the control unit 10 proceeds to step S12. That is, the control unit 10 repeats processing of Step S12 until the target object is displayed.

When it is determined that the target object is being displayed (Yes at Step S12), at Step S14, the control unit 10 determines whether there is a side contact, that is, whether a contact on any one side face has been detected by the contact sensor 4. When it is determined that there is no side contact (No at Step S14), that is, when it is determined that a contact on a side face has not been detected, the control unit 10 causes the process to return to step S12. When it is determined that there is a side contact (Yes at Step S14), that is, when it is determined that a contact on a side face has been detected, at Step S16, the control unit 10 determines whether the contact is the crumpling operation.

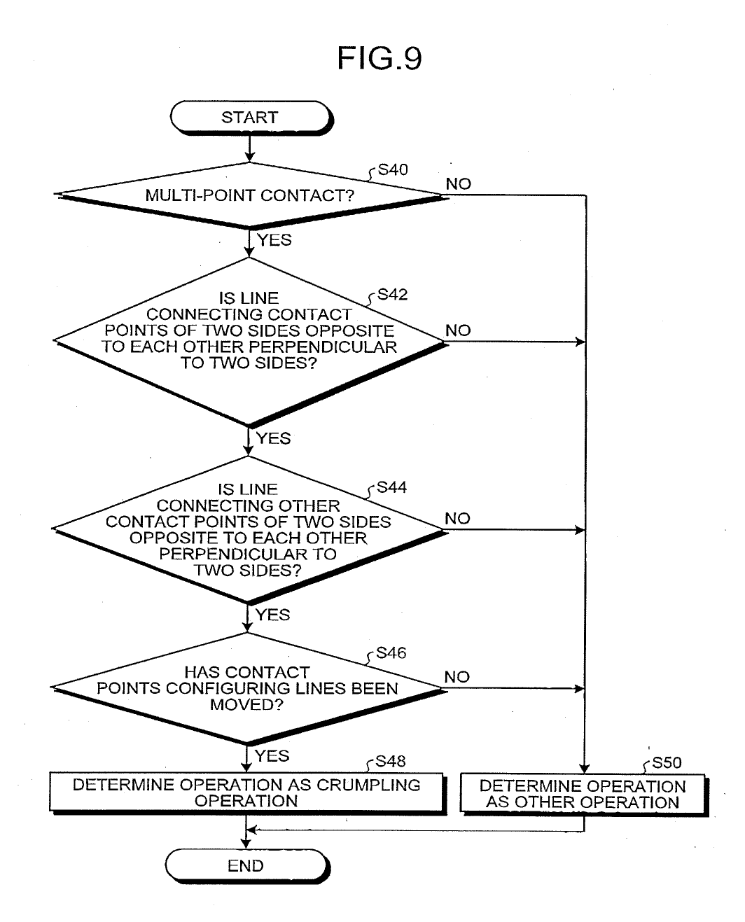

The determination of step S16 will be described with reference to FIG. 9. FIG. 9 is a flowchart illustrating an operation of the mobile phone. The process illustrated in FIG. 9 is based on an example in which the operation illustrated in FIG. 5 is defined as the crumpling operation. At Step S40, the control unit 10 determines whether the contact is a multi-point contact. That is, it is determined whether two or more contacts have been detected by the contact sensor 4. When it is determined that the contact is not the multi-point contact (No at Step S40), the control unit 10 causes the process to proceed to step S50.

When it is determined that the contact is a multi-point contact (Yes at Step S40), at Step S42, the control unit 10 determines whether a line obtained by connecting contact points of corresponding two sides (two faces) to each other is a line that is substantially perpendicular to the two sides. In other words, it is determined whether contact points having a relation such that a line perpendicular to two sides passes through the approximated points thereof are present on opposite two sides. When it is determined that the contact points are not present (No at Step S42), the control unit 10 causes the process to proceed to step S50.

When it is determined that the contact points are present (Yes at Step S42), at Step S44, the control unit 10 determines whether the line obtained by connecting the other contact points of the corresponding two sides to each other is a line that is substantially perpendicular to the two sides. That is, it is determined whether other contact points having a relation such that a line perpendicular to two sides passes through the approximated points thereof are present on opposite two sides except the contact points determined at Step S42. When it is determined that the contact points are not present (No at Step S44), the control unit 10 causes the process to proceed to step S50.

When it is determined that the contact points are present (Yes at Step S44), at Step S46, the control unit 10 determines whether at least one of pairs of the contact points configuring the lines (at least one of contact positions) substantially perpendicular to the two sides have been moved. When it is determined that the contact points have not been moved (No at Step S46), the control unit 10 causes the process to proceed to step S50.

When it is determined that at least one of the contact points have been moved (Yes at Step S46), at Step S48, the control unit 10 determines that the detected operation is the crumpling operation. When the determination result of steps S40, S42, S44, or S46 is No, at Step S50, the control unit 10 determines that the detected operation is any other operation, that is, that the detected operation is not the crumpling operation. When processing of step S48 or S50 is executed, the control unit 10 ends the present determination process. Further, the control unit 10 may change the determination method according to an operation defined as the crumpling operation.

Returning to FIG. 8, the description of the present process is continued. When it is determined that the contact is not the crumpling operation (No at Step S16), at Step S18, the control unit 10 executes processing according to the input operation. The control unit 10 compares a correspondence relation stored in the operation defining data 9E with the input operation and specifies processing to be executed. Thereafter, the control unit 10 executes the specified processing and then causes the process to proceed to step S28.

When it is determined that the contact is the crumpling operation (Yes at Step S16), at Step S20, the control unit 10 calculates a moving distance. That is, an amount of change in a distance between one contact position and the other contact position is calculated. After the moving distance is calculated at Step S20, at Step S22, the control unit 10 changes a display of an object. Specifically, a shrinkage rate or a shrinkage amount of the display area of the object is calculated based on the moving amount calculated at Step S20. Further, an image in which the object is crumpled according to the shrinkage rate is created. The control unit 10 causes the created crumpled image to be displayed on the reduced display area.

After processing of step S22, at Step S24, the control unit 10 performs processing according to an input operation. For example, when the distance between the contact positions is a given threshold value or less, the control unit 10 deletes the object or prompts a pop-up window for querying whether or not the object is to be deleted.

After processing of step S24 is performed, at Step S26, the control unit 10 determines whether the crumpling operation has been ended. The determination as to whether the crumpling operation has been ended can be made based on various criteria. For example, when a contact is not detected by the contact sensor 4, it can be determined that the crumpling operation has been ended.

when it is determined that the crumpling operation has not been ended (No at Step S26), the control unit 10 causes the process to proceed to step S20. The control unit 10 repeats the display change process according to the moving distance until the crumpling operation ends. When it is determined that the crumpling operation has been ended (Yes at Step S26), the control unit 10 causes the process to proceed to step S28.

When processing of step S18 has been performed or when the determination result of step S26 is Yes, at Step S28, the control unit 10 determines whether the process ends, that is, whether operation detection by the contact sensor 4 is to be ended. When it is determined that the process dose not end (No at Step S28), the control unit 10 causes the process to return to step S12. When it is determined that the process ends (Yes at Step S28), the control unit 10 ends the present process.

The mobile phone 1 according to the present embodiment is configured to receive an operation on a side face and execute processing according to the operation received at the side face, thereby providing the user with various operation methods. In other words, as illustrated in FIG. 8, when the contact detected by the contact sensor is not the crumpling operation, processing according to the input is executed, and thus various operations can be input. For example, when an operation of reducing a distance between two contact points detected by a contact sensor of one side (one face) is input, processing of reducing the display area may be performed without crumpling an image. Further, when contact points are detected at corresponding positions (positions regarded as being perpendicular) of opposite two sides and an operation of reducing a distance between the contact positions obtained by connecting the contact points to each other is input, processing of crumpling an image and reducing the display area may be performed.

Aspects of the present invention according to the above embodiments may be arbitrarily modified in a range not departing from the gist of the present invention.

When the mobile phone can process a plurality of applications for displaying an image by multi-tasking and the crumpling operation is input as in the present embodiment, the mobile phone may perform processing corresponding to the crumpling operation on a foreground application image and display a background application image on an area on which the foreground application image (processing target object) is not displayed. In other words, processing based on the crumpling operation is performed, and so the background application image may be displayed on a portion in which the display area is empty. Thus, a currently activated application and an image developed in the background can be intuitively easily recognized. The mobile phone may delete a data file corresponding to an object crumpled by the crumpling operation from a storage unit.

The mobile phone may detect the magnitude of force applied by contact through the contact sensor 4 and display a crumpled image such that as the detected force increases, the number of bending points increases. That is, when an operation of moving a contact position with strong force is performed, a more crumpled image (a significantly wrinkled image) may be displayed. As a result, a change in an image becomes a change suitable for an input operation, and thus an input operation can be intuitively easily recognized.

The above embodiment has been described in connection with the example in which contact positions are narrowed. However, when an operation opposite to the crumpling operation, that is, an operation of stretching contact positions is performed on an image crumpled by the crumpling operation, the mobile phone 1 may increase the display area and display an image having a small number of bending points (an image smoothed out wrinkles) instead of the crumpled image. Thus, a crumpled image can be restored to an original image.

In the above embodiment, the contact sensors are arranged on four sides (four side faces) of the housing as the contact sensor 4; however, the present invention is not limited thereto. The contact sensor that detects a contact on a side face may be arranged at a necessary position. For example, when the processes of FIGS. 5 and 6 are performed, the contact sensors may be arranged only on opposite two sides (two faces). When the process of FIG. 7 is performed, the contact sensors may be arranged on three sides among four sides (three faces among four faces). When the two contact sensors are arranged, the two contact sensors are preferably arranged on two side faces (that is, of long sides) adjacent to the long side of the front face (the face on which the touch panel is arranged). Thus, movement of the finger described with reference to FIGS. 5 and 6 can be used as the crumpling operation, an operation can be easily input, and thus operability can be improved.

The above embodiment has been described in connection with the example in which the present invention is applied to an electronic device having a touch panel as a display unit. However, the present invention can be applied to an electronic device including a simple display panel on which a touch sensor is not superimposed.

In the present embodiment, the contact sensor 4 is used as a contact detecting unit; however, the contact detecting unit is not limited thereto. The touch sensor 2A of the touch panel 2 may be used as the contact detecting unit. In other words, when an operation of reducing a distance between contact positions defined as the crumpling operation is input to the touch panel 2, a display area of an image may be reduced, and a crumpled image may be displayed.

The advantages are that one embodiment of the invention provides an electronic device, an operation control method, and an operation control program that allow a user to recognize an input operation intuitively.

What is claimed is:

1. An electronic device, comprising:
a display unit for displaying a first image;
a contact detecting unit for detecting a contact; and
a control unit for causing the first image displayed on the display unit to be distorted when the contact detecting unit detects an operation in which a plurality of contacts including at least a first contact and a second contact are made and thereafter the first contact is moved in a direction approaching to the second contact.

2. The electronic device according to claim 1, further comprising a housing having a first face, on which the display unit is arranged, and second and third faces interposing the first face therebetween,
wherein the contact detecting unit is arranged on the second face.

3. The electronic device according to claim 2,
wherein the contact detecting unit includes a first detecting unit arranged on the second face and a second detecting unit arranged on the third face,
the plurality of contacts includes: the first contact made on the second face; the second contact made on the second face; a third contact made on the third face; and a fourth contact made on the third face; and
the control unit is configured to cause the first image to be distorted when the contact detecting unit detects the operation in which the first contact is moved in the direction approaching to the second contact on the second face and the third contact is moved in a direction approaching to the fourth contact on the third face.

4. The electronic device according to claim 3,
wherein a line obtained by connecting the first contact and the third contact is substantially perpendicular to the second and third faces.

5. The electronic device according to claim 1,
wherein the control unit is configured to cause the first image to be more significantly distorted in a first direction that the first contact approaches to the second contact than in a second direction perpendicular to the first direction.

6. The electronic device according to claim 1,
wherein the control unit is configured to create a distorted image by bending or curving outer circumference of the first image while maintaining a total length of the outer circumference of the first image and causes the distorted image to be displayed on the display unit instead of the first image when causing the first image to be distorted.

7. The electronic device according to claim 1,
wherein the contact detecting unit is configured to detect pressure applied by a contact, and
the control unit is configured to cause the first image to be more significantly distorted as the pressure of the contacts detected by the contact detecting unit increases.

8. The electronic device according to claim 1,
wherein the control unit is configured to stop displaying the first image displayed on the display unit when a distance by which the first contact approaches to the second contact is larger than a threshold value.

9. The electronic device according to claim 1,
wherein the control unit is configured to execute a plurality of applications including a first application for displaying the first image and a second application for displaying a second image by multitasking, and
the control unit causes the first image displayed on the display unit to be distorted and causes the second image to be displayed behind the distorted first image when the operation is detected while the first application is executed in foreground and the second application is executed in background.

10. An operation control method executed by an electronic device including a display unit and a contact detecting unit, the operation control method comprising:
displaying an image on the display unit;
detecting, by the contact detecting unit, an operation in which a plurality of contacts including at least a first contact and a second contact are made and thereafter the first contact is moved in a direction approaching to the second contact; and
distorting the image displayed on the display unit when the operation is detected.

11. A non-transitory storage medium that stores an operation control program causing, when executed by an electronic device which includes a display unit and a contact detecting unit, the electronic device to execute:
displaying an image on the display unit;
detecting, by the contact detecting unit, an operation in which a plurality of contacts including at least a first contact and a second contact are made and thereafter the first contact is moved in a direction approaching to the second contact; and
distorting the image displayed on the display unit when the operation is detected.
